(19) United States
(12) Patent Application Publication
(10) Pub. No.: US 2017/0279883 A1
(43) Pub. Date: Sep. 28, 2017

(54) METHOD, STORAGE MEDIUM, AND SYSTEM

(71) Applicant: FUJITSU LIMITED, Kawasaki-shi (JP)

(72) Inventor: Osamu SHIMOKUNI, Kawasaki (JP)

(73) Assignee: FUJITSU LIMITED, Kawasaki-shi (JP)

(21) Appl. No.: 15/421,776

(22) Filed: Feb. 1, 2017

(30) Foreign Application Priority Data
Mar. 24, 2016 (JP) 2016-059688

(51) Int. Cl. H04L 29/08; H04L 12/713; H04L 12/24; H04L 12/751

(52) U.S. Cl. CPC H04L 67/1031; H04L 45/02; H04L 45/586; H04L 41/0893

(57) ABSTRACT

A method includes: determining a group in which communication between virtual machines belonging to the group is not permitted by referring information regarding communication rules on virtual machines belonging to individual groups; storing deployment information indicating dispersed deployment in association with identification information on the determined group; determining whether the deployment information associated with identification information on a first group is stored when receiving an instruction to deploy a first virtual machine belonging to the first group; and determining a target physical machine in which the first virtual machine is to be deployed from among one or more physical machines in which a second virtual machine other than the first virtual machine belonging to the first group is not running out of physical machines when determining that the deployment information is stored in association with the identification information on the first group.

### CROSS-REFERENCE TO RELATED APPLICATION

This application is based upon and claims the benefit of priority of the prior Japanese Patent Application No. 2016-059688, filed on Mar. 24, 2016, the entire contents of which are incorporated herein by reference.

### FIELD

This embodiment relates to a technique for deploying virtual machines.

### BACKGROUND

In an infrastructure-as-a-service (IaaS) system, the processing performance of virtual machines (VMs) and communication speed between the VMs change depending on a physical machine in which the VMs are deployed. Accordingly, VMs are deployed according to a configuration for deployment created in advance by the user of the VMs.

The configuration for deployment is created in consideration of the functions of the individual VMs (for example, a web server, an application server, and a database server), the specifications of the physical machine, and so on, but this operation takes much time and labor.

As examples of the related art, Japanese Laid-open Patent Publication No. 2009-199395, International Publication Pamphlet No. WO 2015/040788, and Japanese Laid-open Patent Publication No. 2010-140134 are known.

### SUMMARY

According to an aspect of the invention, a method for deploying virtual machines, the method includes: first determining a group in which communication between virtual machines that belong to the group is not permitted by referring information regarding communication rules on virtual machines that belong to individual groups in a first data storage; storing deployment information indicating dispersed deployment in a second data storage in association with identification information on the determined group; second determining whether the deployment information associated with identification information on a first group is stored in the second data storage when receiving an instruction to deploy a first virtual machine that belongs to the first group; and third determining a target physical machine in which the first virtual machine is to be deployed from among one or more physical machines in which a second virtual machine that belongs to the first group is not running out of a plurality of physical machines when the second determining determines that the deployment information is stored in the second data storage in association with the identification information on the first group, the second virtual machine being a virtual machine other than the first virtual machine.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating, in outline, the configuration of a system according to an embodiment;

FIG. 2 is a diagram illustrating data storage sections in a management-data storage unit;

FIG. 3 is a functional block diagram of a VM controller;

FIG. 4 is a diagram illustrating an example of a management table stored in a SG-data storage section;

FIG. 5 is a diagram illustrating an example of a management table stored in a rule-data storage section;

FIG. 6 is a diagram illustrating an example of a management table stored in an AAF-group-data storage section;

FIG. 7 is a diagram illustrating an example of a management table stored in a COM-group-data storage section;

FIG. 8 is a diagram illustrating an example of a management table stored in a VM-management-data storage section;

FIG. 9 is a diagram for illustrating security groups;

FIG. 10 is a diagram for illustrating a VM scheduler;

FIGS. 11, 12, 13A, and 13B are diagrams for illustrating an AAF group;

FIG. 14 is a diagram for illustrating a COM group;

FIG. 15 is a flowchart for generating an AAF group and a COM group;

FIG. 16 is a flowchart for an AAF-group generation process;

FIG. 17 is a flowchart for a COM-group generation process;

FIG. 18 is a flowchart for a process for determining a destination physical machine based on a generated AAF group and COM group;

FIG. 19A is a flowchart for an AAF setting process;

FIG. 19B is a diagram illustrating an example of a command executed at startup;

FIG. 20 is a flowchart for a communication-cost calculation process;

FIG. 21A is a flowchart for the communication-cost calculation process;

FIG. 21B is a diagram illustrating an example of a calculated communication cost;

FIG. 22 is a flowchart for a process executed by a hypervisor in a destination physical machine;

FIGS. 23, 24, 25, 26, 27, and 28 are diagrams for illustrating examples of the operation of a deployment apparatus; and

FIG. 29 is a functional block diagram of a computer.

### DESCRIPTION OF EMBODIMENTS

An object of this embodiment is to provide a technique for deploying virtual machines in suitable physical machines even if a configuration for deployment is not prepared.

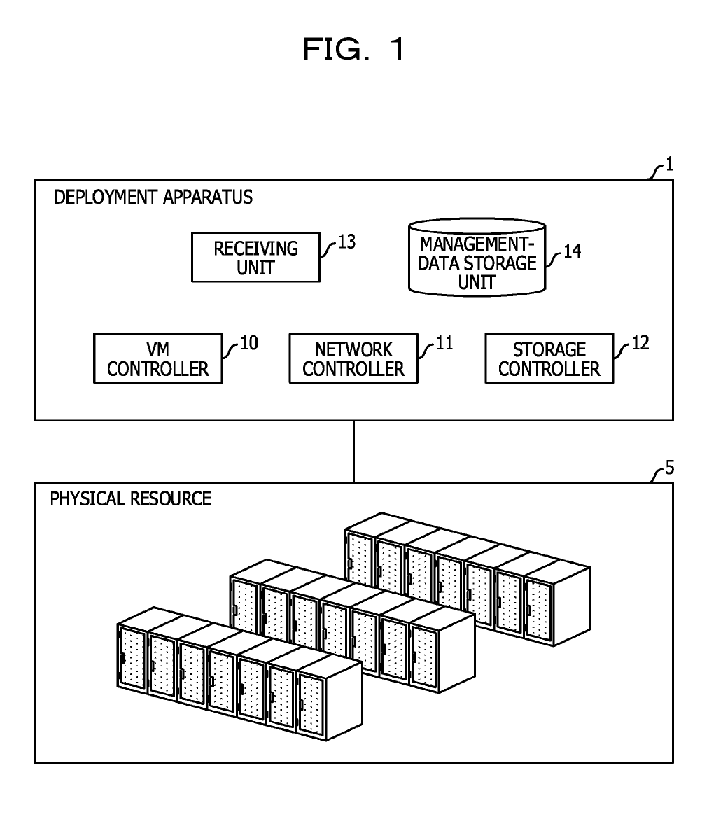

FIG. 1 illustrates, in outline, the configuration of a system according to an embodiment. A deployment apparatus 1 that executes major processes of this embodiment is connected to individual devices in a physical resource 5 (in this embodiment, physical machines, network devices, storage devices, and so on).

The deployment apparatus 1 includes a VM controller 10, a network controller 11, a storage controller 12, a receiving unit 13, and a management-data storage unit 14. The VM controller 10 executes a process for deploying, updating, and removing VMs in the physical resource 5. The network controller 11 executes a process for deploying, updating, and removing virtual network devices such as a virtual switch and a virtual router in the physical resource 5. The storage controller 12 executes a process for deploying, updating, and removing virtual storage devices in the physical resource 5. The VM controller 10, the network controller 11, and the storage controller 12 acquire information on the status of use, failure information, and so on from the physical resource 5 and store the information in the management-data storage unit 14. The receiving unit 13 executes a process for receiving instructions from the user via a network or an input device.

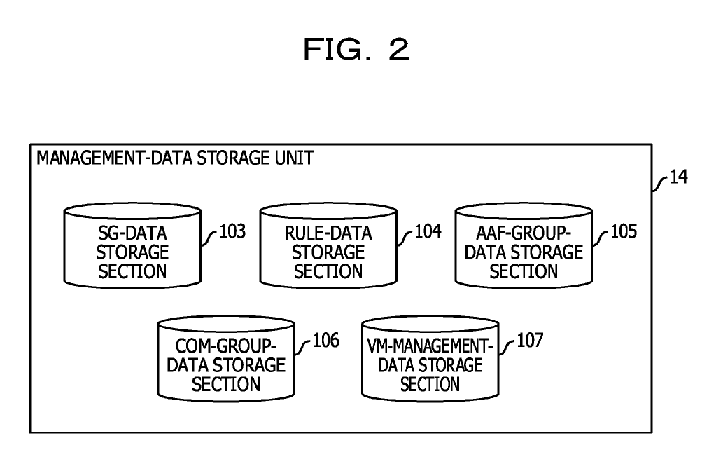

FIG. 2 illustrates data storage sections in the management-data storage unit 14. The management-data storage section 14 includes a security-group (SG)-data storage section 103 that stores a management table on a security group, a rule-data storage section 104 that stores a management table on communication rules, an anti-affinity (AAF)-group-data storage section 105 that stores a management table on an AAF group, a community (COM)-group-data storage section 106 that stores a management table on a COM group, and a VM-management-data storage section 107 that stores a management table on VMs. The SG group, the AAF group, and the COM group are described later.

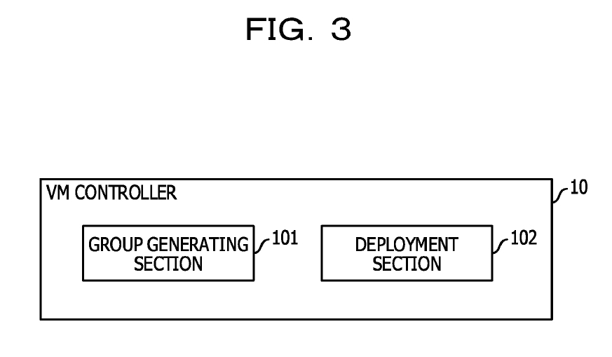

FIG. 3 illustrates a functional block diagram of the VM controller 10. The VM controller 10 includes a group generating section 101 and a deployment section 102.

The group generating section 101 generates an AAF-group management table based on the management table stored in the SG-data storage section 103 and the management table stored in the rule-data storage section 104 and stores the generated AAF-group management table in the AAF-group-data storage section 105. The deployment section 102 performs processing based on the management table stored in the AAF-group-data storage section 105 and stores the processing result in the VM-management-data storage section 107. The deployment section 102 executes a process for deploying VMs in the physical resource 5 based on the VM management table stored in the VM-management-data storage section 107 and the management table stored in the COM-group-data storage section 106.

In physical machines in the physical resource 5, hypervisors (also referred to as virtualization software) run, and VMs and so on run on the virtualization software.

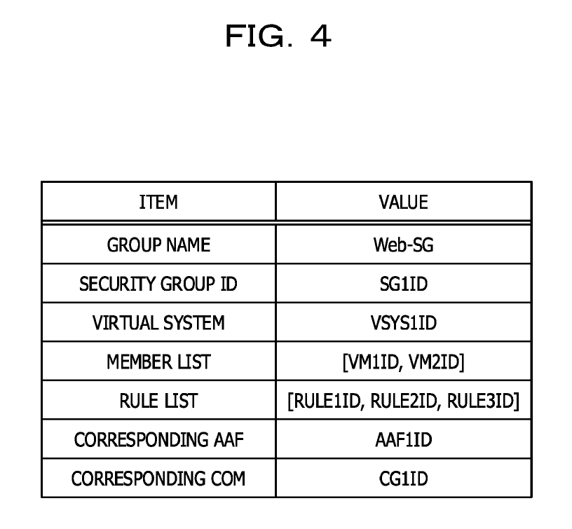

FIG. 4 illustrates an example of the management table stored in the SG-data storage section 103. In the example in FIG. 4, the SG-data storage section 103 stores security group name, the universally unique identifier (UUID) of the security group, the UUID of a virtual system to which VMs in the group belong, a list of the UUIDs of the members of the security group, a list of the UUIDs of communication rules for the VMs of the security group, the UUID of an AAF group corresponding to the security group, and the UUID of a COM group corresponding to the security group.

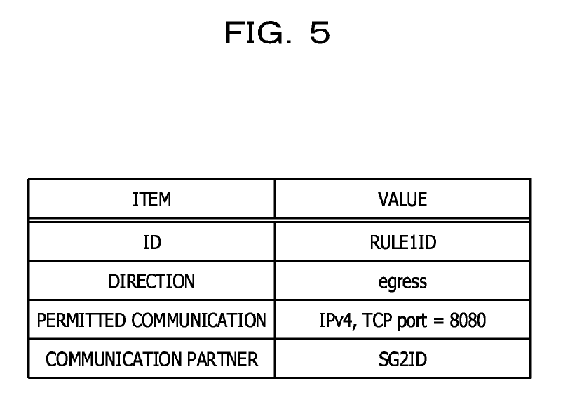

FIG. 5 illustrates an example of the management table stored in the rule-data storage section 104. In the example in FIG. 5, the management table contains the UUID of the communication rule, information indicating a communication direction, information for specifying permitted communication, and information indicating a communications partner. The information indicating a communication direction in this embodiment is “egress” or “ingress”. The information for specifying permitted communication in this embodiment is information on a packet header that specifies the communication. The information indicating a communications partner in this embodiment is an Internet protocol (IP) address or the UUID of the security group.

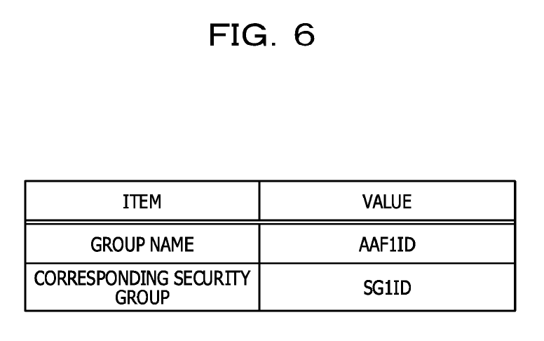

FIG. 6 illustrates an example of the management table stored in the AAF-group-data storage section 105. In the example in FIG. 6, the management table contains group name (in this embodiment, UUID) and the UUID of a security group corresponding to the AAF group.

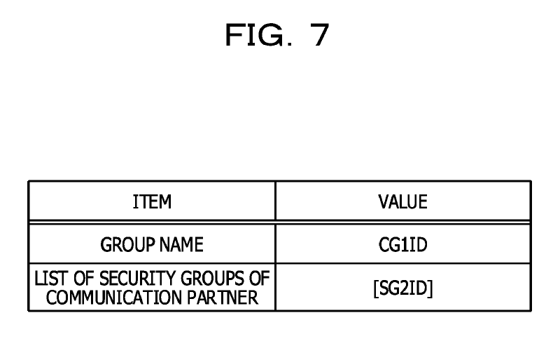

FIG. 7 illustrates an example of the management table stored in the COM-group-data storage section 106. In the example in FIG. 7, the management table contains group name (in this embodiment, UUID) and a list of the UUIDs of security groups of its communication partner.

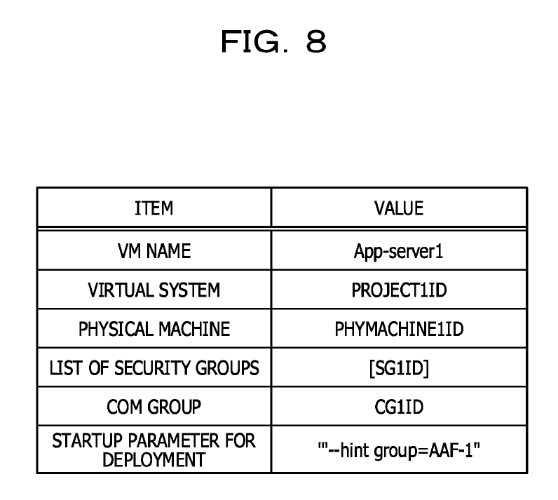

FIG. 8 illustrates an example of the management table stored in the VM-management-data storage section 107. In the example in FIG. 8, the management table contains VM name, the UUID of a virtual system to which the VM belongs, the UUID of a physical machine in which the VM runs, a list of the UUIDs of security groups to which the VM belongs, the UUID of a COM group to which the VM belongs, and a startup parameter for deployment of the VM. Although the management table may contain other information, the information has no direct relation to this embodiment, and a description thereof is omitted.

Although the management-data storage unit 14 may store other data, a description thereof is omitted here.

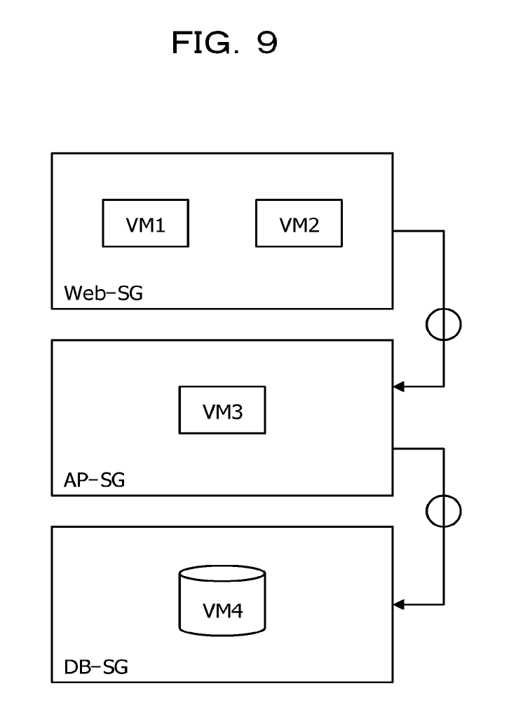

Referring now to FIGS. 9 to 14, matters related to this embodiment are briefly described.

FIG. 9 is a diagram for illustrating security groups. Each security group is a group of VMs in which the same communication rules are set. The communication rules include a rule on a communication direction, a rule on a permitted protocol and port number, and a rule on a communication partner, as illustrated in FIG. 5. In the example in FIG. 9, a security group Web-SG, a security group application (AP)-SG, and a security group database (DB)-SG are defined. Communication from Web-SG to AP-SG and communication from AP-SG to DB-SG are permitted. However, communication from Web-SG to DB-SG is not permitted. Communication between VMs in Web-SG is not permitted. Communication between VMs in each group is permitted by specifying explicitly the group as a communication partner.

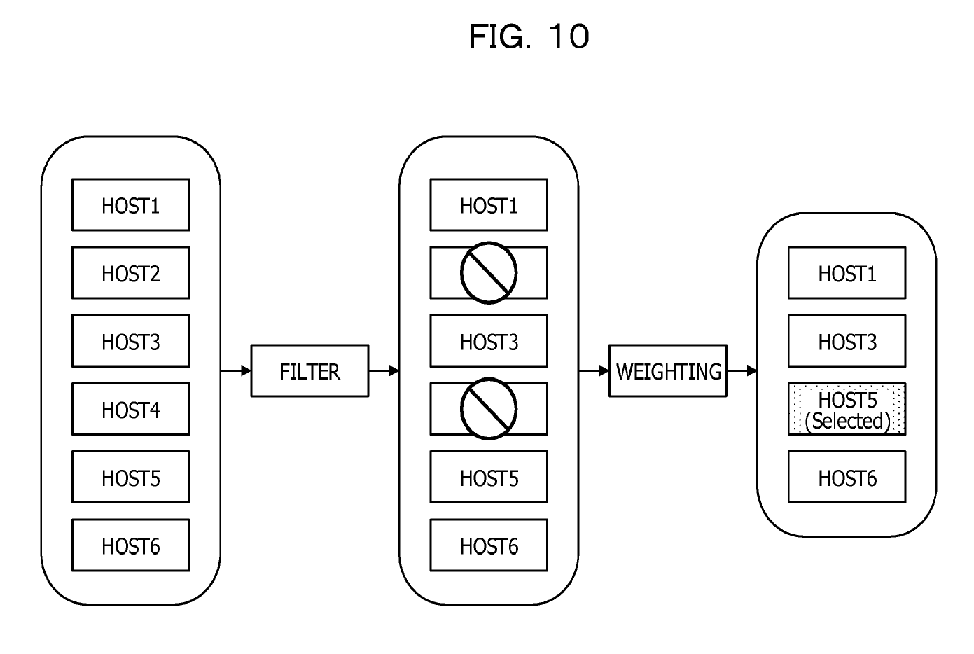

FIG. 10 is a diagram for illustrating a VM scheduler. The VM scheduler is provided in the VM controller 10 and determines the state of the physical machines and the disposition of the VMs in the physical resource 5 based on scheduling settings. In this embodiment, scheduling is performed by a process called “Filter” and a process called “Weighting”, as illustrated in FIG. 10. In Filter, executed is a process for removing from the candidates a physical machine in which a physical resource, such as a central processing unit (CPU) or a memory, runs short and a physical machine that is not to be deployed in view of the settings, from physical machines in the physical resource 5. In the example in FIG. 10, HOST2 and HOST4 are removed from the candidates. In Weighting, executed is a process of calculating a cost when a VM is deployed in each of physical machines in which VMs may be deployed. Functions for calculating the cost are set by the administrator of the IaaS, and a lowest-cost physical machine is selected. In the example in FIG. 10, HOST5 is selected. If a plurality of lowest-cost physical machines are present, a lowest-cost physical machine is selected at random from the plurality of physical machines. In this embodiment, a function for calculating a communication cost is used.

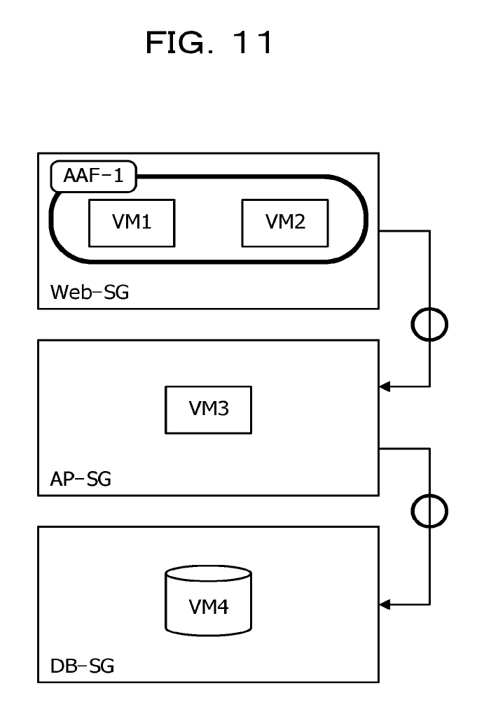

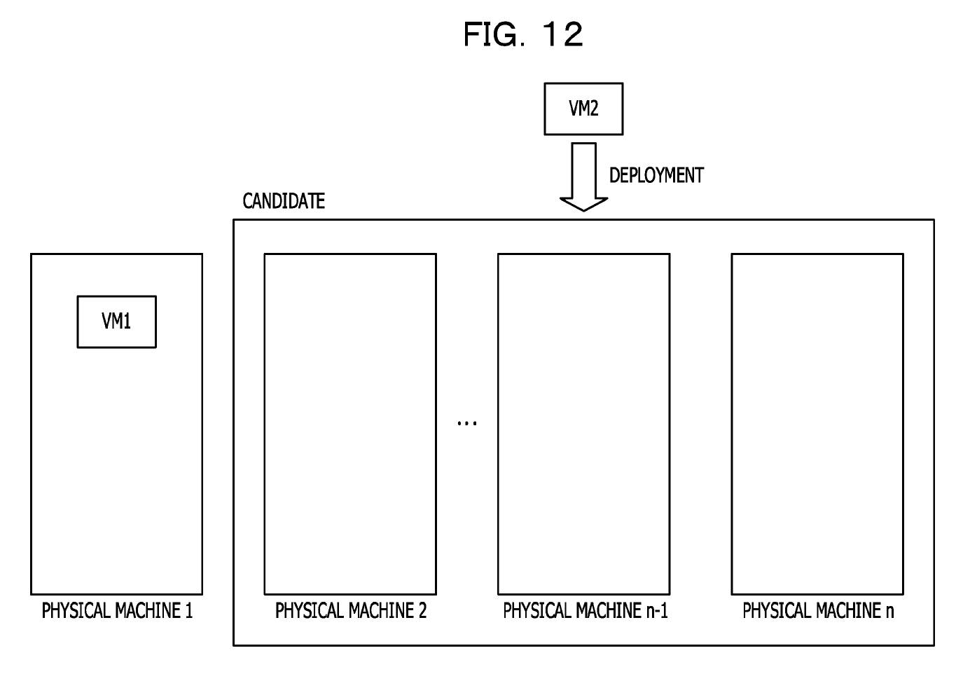

FIGS. 11, 12, 13A, and 13B are diagrams for illustrating an AAF group. Like VM1 and VM2 illustrated in FIG. 11, a plurality of VMs having the same function may be deployed in different physical machines as much as possible so that not all the VMs go down when the physical machines go down (that is, the availability is enhanced). In such a case, the AAF group is established in Web-SG. In the example in FIG. 11, a security group “AAF-1” is established in the Web-SG. For example, as illustrated in FIG. 12, when VM2 is to be newly deployed while VM1 is running in the physical machine 1, a physical machine is selected from physical machines 2 to n other than the physical machine 1.

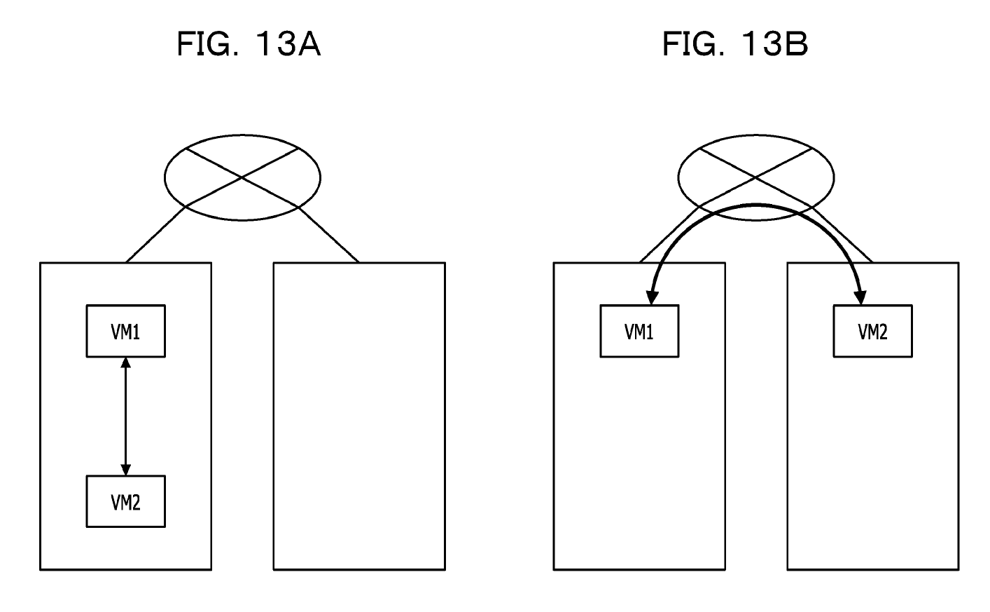

Deploying VMs in different physical machines may be undesirable from the viewpoint of communication efficiency. For communication between VM1 and VM2, deploying VM1 and VM2 in the same physical machine, as illustrated in FIG. 13A, may reduce consumption of the network band, enhancing communication efficiency. In contrast, deploying VM1 and VM2 in different physical machines, as illustrated in FIG. 13B, may increase consumption of the network band, decreasing the communication efficiency. Deploying a plurality of VMs in the same physical machine in this manner is also referred to as “Affinity”.

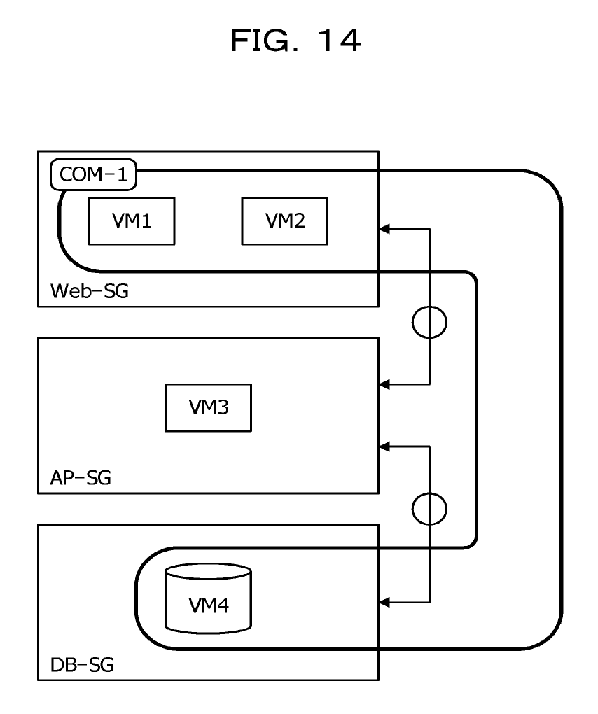

FIG. 14 is a diagram for illustrating a COM group. The COM group is a security group of a communication partner. In the example in FIG. 14, VM3 communicates with VM1 and VM2 of Web-SG and VM4 of DB-SG. In this case, a COM group (“COM-1” in FIG. 14) corresponding to AP-SG includes Web-SG and DB-SG. In this embodiment, the COM group is adopted to calculate the communication cost.

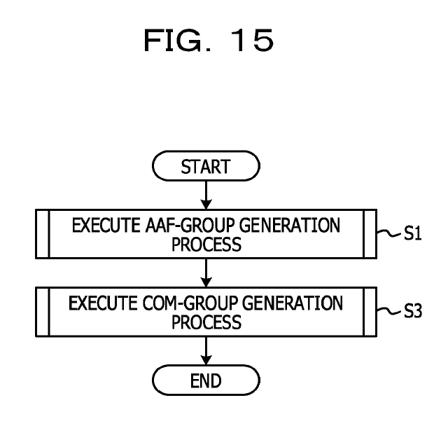

In this embodiment, an AAF group and a COM group are generated for a target security group. In newly starting a VM of the target security group, a destination physical machine is determined based on the generated AAF group and COM group. Referring to FIGS. 15, 16, and 17, first a process for generating an AAF group and a COM group is described.

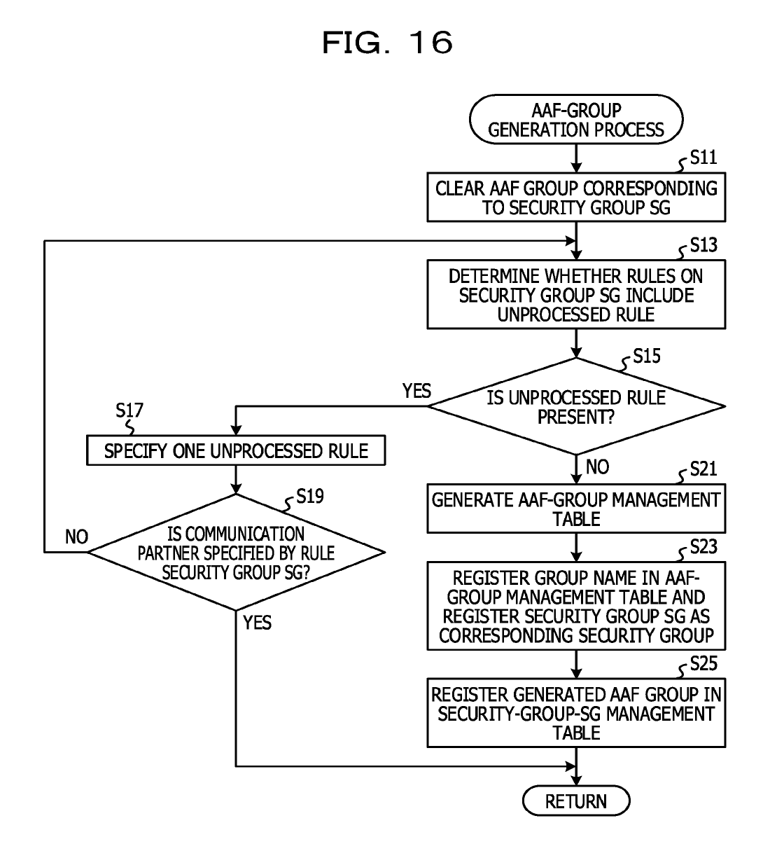

FIG. 15 illustrates a flowchart for generating an AAF group and a COM group. The receiving unit 13 of the deployment apparatus 1 receives a security-group update instruction, including the UUID of the security group, from the user or the administrator of the virtual system. In response to that, the group generating section 101 in the VM controller 10 executes an AAF-group generation process (FIG. 15: step S1). The AAF-group generation process is described with reference to FIG. 16. FIG. 16 illustrates a flowchart for the AAF-group generation process.

First, the group generating section 101 clears an AAF group corresponding to a security group (hereinafter referred to as a security group SG) stored in the SG-data storage section 103 and indicated by an update instruction, (FIG. 16: step S11).

The group generating section 101 determines whether rules on the security group SG stored in the SG-data storage section 103 include an unprocessed rule (step S13). If the rules include an unprocessed rule (step S15: Yes), the group generating section 101 specifies one unprocessed rule (step S17).

The group generating section 101 specifies a communication partner stipulated by the rule specified at step S17 from the rule-data storage section 104. Then, the group generating section 101 determines whether the specified communication partner is the security group (that is, the security group SG) (step S19).

If the specified communication partner is not the security group SG (step S19: No), the process returns to the process at step S13 to process the next rule. In contrast, if the specified communication partner is the security group SG (step S19: Yes), communication is performed between VMs in the security group SG, so that no AAF group may be generated. Therefore, the process returns to the process of the invoker.

In contrast, if the rules include no unprocessed rule (step S15: No), the group generating section 101 newly generates an AAF-group management table in the AAF-group-data storage section 105 (step S21). At step S21, an empty management table is generated.

The group generating section 101 registers a group name (that is, UUID) in the management table generated at step S21. Furthermore, the group generating section 101 registers the group name (that is, UUID) of the security group SG as a corresponding security group name in the management table generated at step S21 (step S23).

The group generating section 101 registers the UUID of a generated AAF group in the security-group-SG management table stored in the SG-data storage section 103 (step S25). Then the process returns to the process of the invoker.

Executing the above process allows an AAF group to be generated when communication between VMs in the security group SG is not performed.

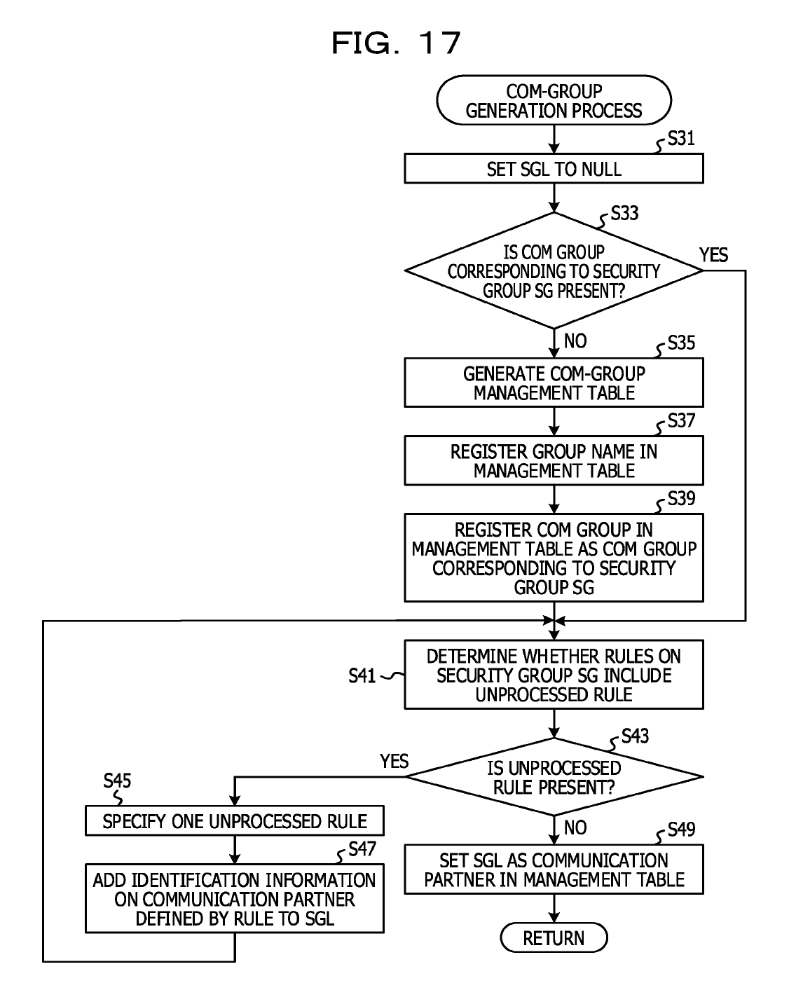

Referring back to FIG. 15, the group generating section 101 executes a COM-group generation process (step S3). The COM-group generation process is described with reference to FIG. 17. FIG. 17 illustrates a flowchart for the COM-group generation process.

First, the group generating section 101 sets a security group list SGL to NULL (that is, empty) (FIG. 17: step S31).

The group generating section 101 determines whether a COM group corresponding to the security group SG is registered in the SG-data storage section 103 (step S33).

If a COM group corresponding to the security group SG is registered (step S33: Yes), the process goes to step S41. In contrast, if a COM group corresponding to the security group SG is not registered, (step S33: No), the group generating section 101 newly generates a COM-group management table in the COM-group-data storage section 106 (step S35).

The group generating section 101 registers the group name (in this embodiment, UUID) in the COM-group management table generated at step S35 (step S37).

The group generating section 101 registers the same group name as that registered at step S37 as a COM group corresponding to the security group SG in the security-group-SG management table stored in the SG-data storage section 103 (step S39).

The group generating section 101 specifies a rule to be applied to the security group SG from the security-group-SG management table stored in the SG-data storage section 103 (step S41).

The group generating section 101 determines whether the rules specified at step S41 include an unprocessed rule (step S43).

If the specified rules include an unprocessed rule (step S43: Yes), the group generating section 101 specifies one unprocessed rule (step S45). Then, the group generating section 101 adds identification information on a communication partner defined by the rule specified at step S45 to SGL (step S47). The process returns to step S41.

In contrast, if the specified rules include no unprocessed rule (step S43: No), the group generating section 101 registers the SGL as a communication partner in the COM-group management table having the group name registered at step S37 (step S49). The process returns to the process of the invoker and ends.

Executing the above process allows a COM group including a security group that may be a communication partner of a VM that belongs to the security group SG to be generated.

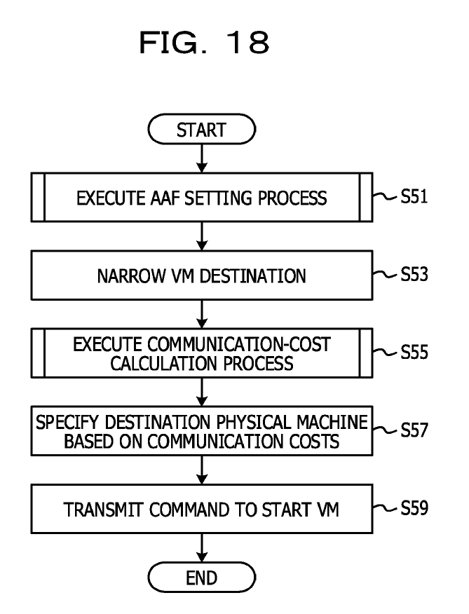

Referring next to FIGS. 18, 19, 20, 21, and 22, a process for determining a destination physical machine based on the generated AAF group and COM group is described. Suppose that the receiving unit 13 receives a deployment instruction including an indication of a VM to be newly started and that a management table on the VM is registered in the VM-management-data storage section 107. FIG. 18 illustrates a flowchart for a process for determining a destination physical machine based on the generated AAF group and COM group.

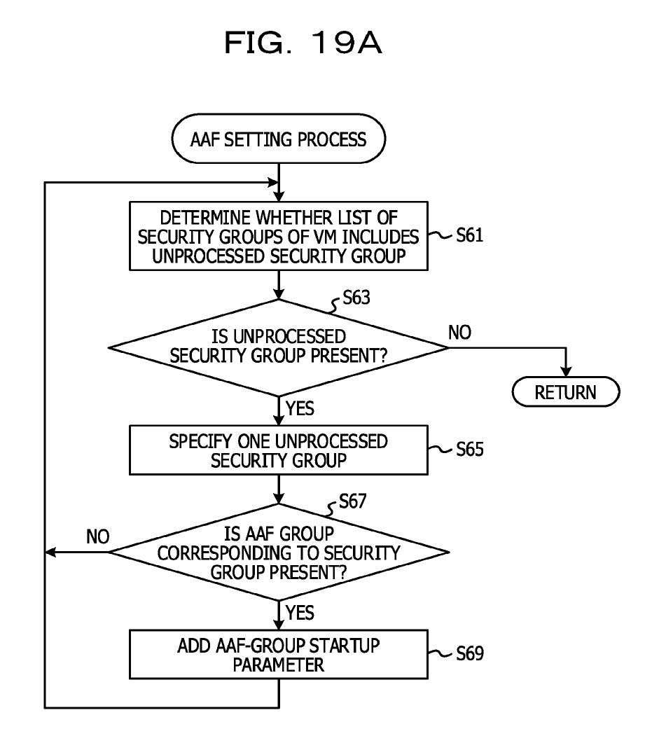

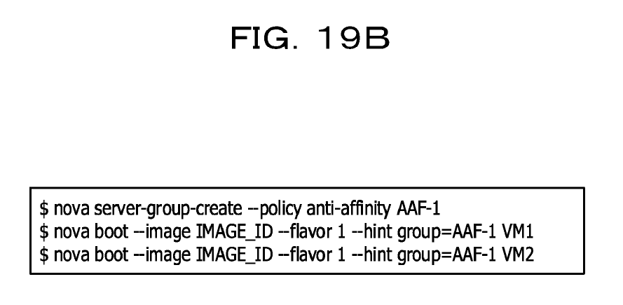

First, the deployment section 102 executes an AAF setting process (FIG. 18: step S51). The AAF setting process is described with reference to FIG. 19A. FIG. 19A illustrates a flowchart for the AAF setting process.

First, the deployment section 102 specifies a list of security groups to which a VM to be started belongs from the VM-management-data storage section 107 and determines whether the specified list includes an unprocessed security group (FIG. 19A: step S61).

If the specified list includes no unprocessed security group (step S63: No), the process returns to the process of the invoker. In contrast, if the specified list includes an unprocessed security group (step S63: Yes), the deployment section 102 specifies one unprocessed security group (step S65).

The deployment section 102 determines whether an AAF group corresponding to the security group specified at step S65 is registered in the SG-data storage section 103 (step S67). If an AAF group corresponding to the security group specified at step S65 is not registered in the SG-data storage section 103 (step S67: No), the process returns to step S61.

In contrast, if an AAF group corresponding to the security group specified at step S65 is registered in the SG-data storage section 103 (step S67: Yes), the deployment section 102 stores a startup parameter for the AAF group corresponding to the security group in the VM-management-data storage section 107 (step S69). The process returns to the process at step S61.

The above process allows consideration of settings for an AAF group corresponding to the security group to which the VM belongs when the VM is to be started. An example of a command executed at startup is illustrated in FIG. 19B for reference. As illustrated in FIG. 19B, a boot-up command includes “--hint group=AAF-1” as a startup parameter.

Referring back to FIG. 18, the deployment section 102 executes a process for narrowing a destination physical machine in which the VM to be started is to be deployed based on the startup parameter stored in the management table on the VM to be started. Specifically, the deployment section 102 specifies from the SG-data storage section 103 a security group corresponding to the AAF group designated by the startup parameter contained in the management table on the VM to be started. The deployment section 102 specifies a physical machine in which the VM that belongs to the specified security group runs from the VM-management-data storage section 107 and sets a physical machine other than the specified physical machine as a destination.

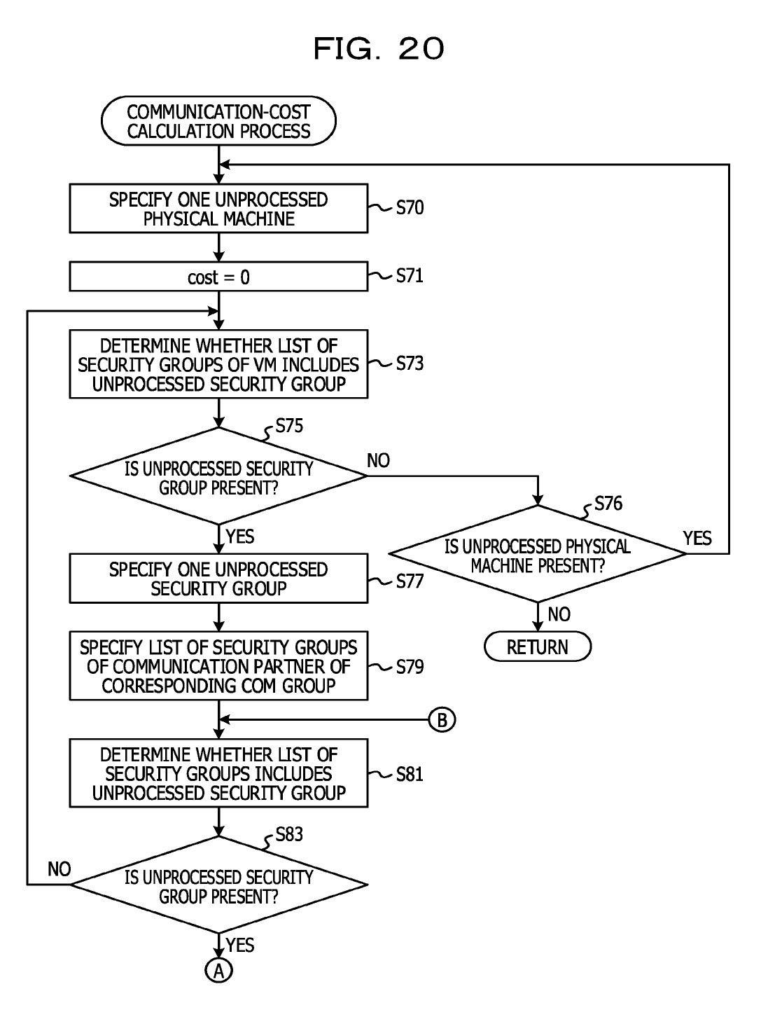

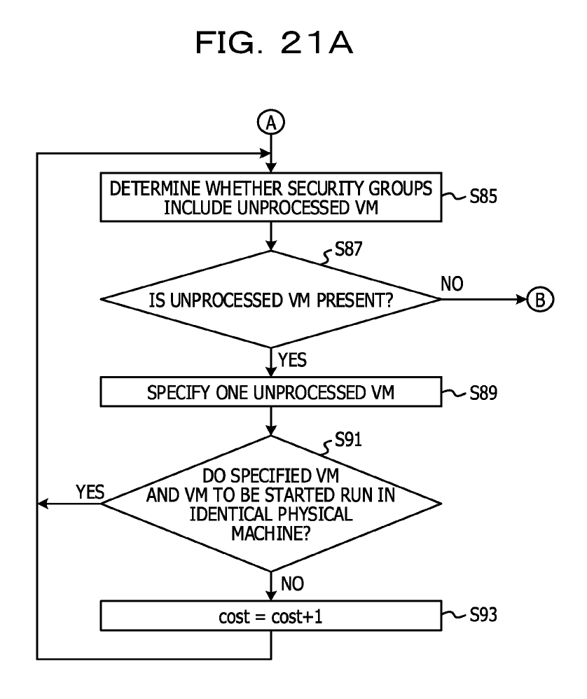

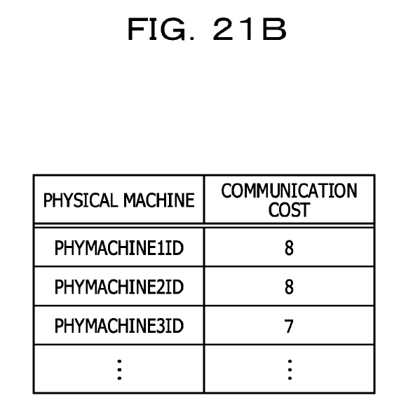

The deployment section 102 executes a communication-cost calculation process (step S55). The communication-cost calculation process is described with reference to FIGS. 20, 21A, and 21B. FIG. 20 illustrates a flowchart for the communication-cost calculation process.

First, the deployment section 102 specifies one unprocessed physical machine from among physical machines contained in the result of the narrowing process at step S53 (that is, physical machines in which VMs that belong to the same security group are not running) (FIG. 20: step S70).

The deployment section 102 sets a variable cost, indicating the communication cost to cost=0 (step S71).

The deployment section 102 specifies a list of security groups to which the VM to be started belongs from the VM-management-data storage section 107 and determines whether the specified list includes an unprocessed security group (step S73).

If the specified list includes no unprocessed security group (step S75: No), the deployment section 102 stores the communication cost calculated for the physical machine specified at step S70 in a storage device, such as a main memory. The deployment section 102 determines whether physical machines included in the result of the narrowing process at step S53 (that is, physical machines in which VMs that belong to the same security group are not running) includes an unprocessed physical machine (step S76).

If the result of the narrowing process includes an unprocessed physical machine (step S76: Yes), the process returns to step S70. In contrast, if no unprocessed physical machine is present (step S76: No), the process returns to the process of the invoker.

In contrast, if the specified list includes an unprocessed security group (step S75: Yes), the deployment section 102 specifies one unprocessed security group (step S77).

The deployment section 102 specifies a COM group corresponding to the security group specified at step S77 from the SG-data storage section 103. Then, the deployment section 102 specifies a list of security groups of the communication partner of the specified COM group from the COM-group-data storage section 106 (step S79).

The deployment section 102 determines whether the list specified at step S79 includes an unprocessed security group (step S81). If the list includes no unprocessed security group (step S83: No), the process returns to the process at step S73. In contrast, if the list includes an unprocessed security group (step S83: Yes), the process goes to step S85 in FIG. 21A through the connector A. FIG. 21A illustrates a flowchart for the communication-cost calculation process.

Referring to FIG. 21A, the deployment section 102 specifies one unprocessed security group from the list specified at step S79 and determines whether the specified security group includes an unprocessed VM (FIG. 21A: step S85).

If the list includes no unprocessed VM (step S87: No), the process returns to step S81 in FIG. 20 through the connector B. In contrast, if the list includes an unprocessed VM (step S87: Yes), the deployment section 102 specifies one unprocessed VM (step S89).

Then, the deployment section 102 specifies a physical machine in which the VM specified at step S89 is running from the VM-management-data storage section 107 and determines whether the specified physical machine is the same as the physical machine specified at step S70 (step S91). That is, the deployment section 102 determines whether the VM specified at step S89 and the VM to be started run in the same physical machine.

If the VM specified at step S89 and the VM to be started run in the same physical machine (step S91: Yes), the communication cost is 0, and therefore the process returns to the process at step S85.

In contrast, if the VM specified at step S89 and the VM to be started do not run in the same physical machine (step S91: No), the deployment section 102 sets the communication cost to cost=cost+1 (step S93). The process returns to the process at step S85.

Thus, the communication cost is calculated for each physical machine, as illustrated in FIG. 21B. FIG. 21B illustrates an example of the calculated communication costs.

Referring back to FIG. 18, the deployment section 102 specifies a destination physical machine based on the communication costs calculated at step S55 (step S57). For example, a physical machine whose communication cost is lowest is specified as the destination. If there are a plurality of physical machines whose communication costs are lowest, one of the physical machines may be selected at random.

The deployment section 102 generates a command for starting a VM in the physical machine specified at step S57 and transmits the command to the physical resource 5 (step S59), and the process ends.

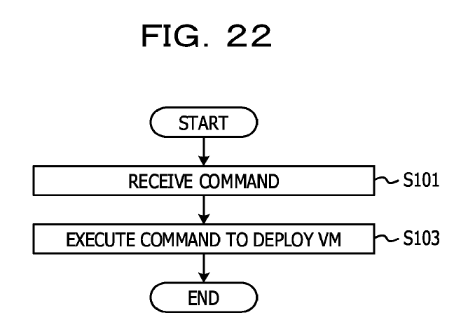

FIG. 22 is a flowchart for a process executed by a hypervisor in a destination physical machine. Referring to FIG. 22, the process executed by a hypervisor in a destination physical machine is described.

First, the hypervisor in the destination physical machine receives a command to start a VM from the deployment apparatus 1 (FIG. 22: step S101). The hypervisor in the destination physical machine executes the received command to deploy the VM (step S103), and the process ends.

As described above, in this embodiment, AAF groups are established from information about communication rules on VMs that belong to security groups. This allows VMs to be deployed in appropriate destinations even if the user does not prepare a configuration for deployment.

Furthermore, optimum physical machines may be specified based on the communication costs. This may reduce occurrence of problems in communication (for example, network congestion) after VMs are deployed.

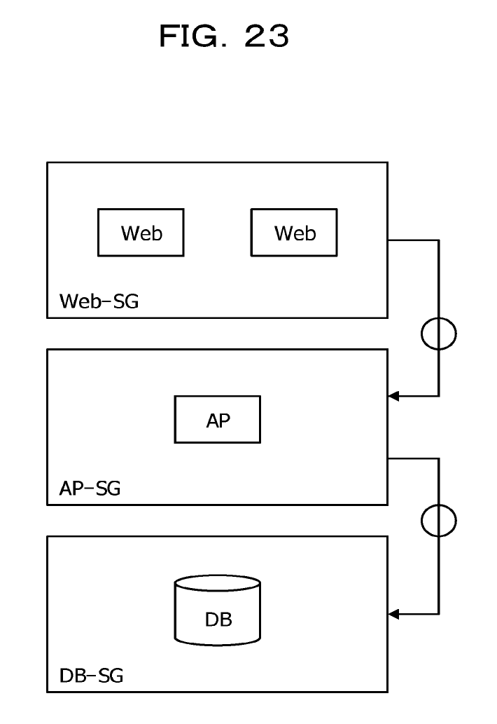

An example of the operation of the deployment apparatus 1 is described hereinbelow with reference to FIGS. 23, 24, 25, 26, 27, and 28. FIGS. 23, 24, 25, 26, 27, and 28 are diagrams for illustrating an example of the operation of the deployment apparatus 1.

Here, assume a virtual system as illustrated in FIG. 23. In FIG. 23, two VMs that belong to Web-SG operate as web servers, one VM that belongs to AP-SG operates as an application server, and one VM that belongs to DB-SG operates as a database server. Communication from Web-SG to AP-SG and communication from AP-SG to DB-SG are permitted. In each security group, communication between VMs is not permitted.

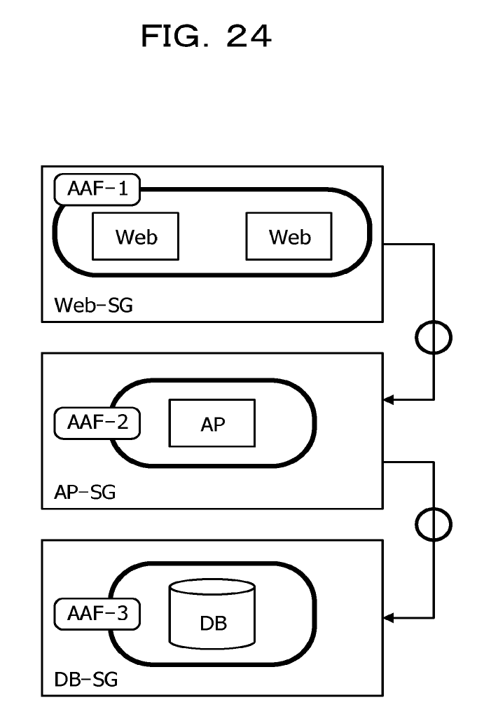

As illustrated in FIG. 24, an AAF group is established in each security group. Specifically, an AAF group “AAF-1” is established in Web-SG, an AAF group “AAF-2” is established in AP-SG, and an AAF group “AAF-3” is established in DB-SG.

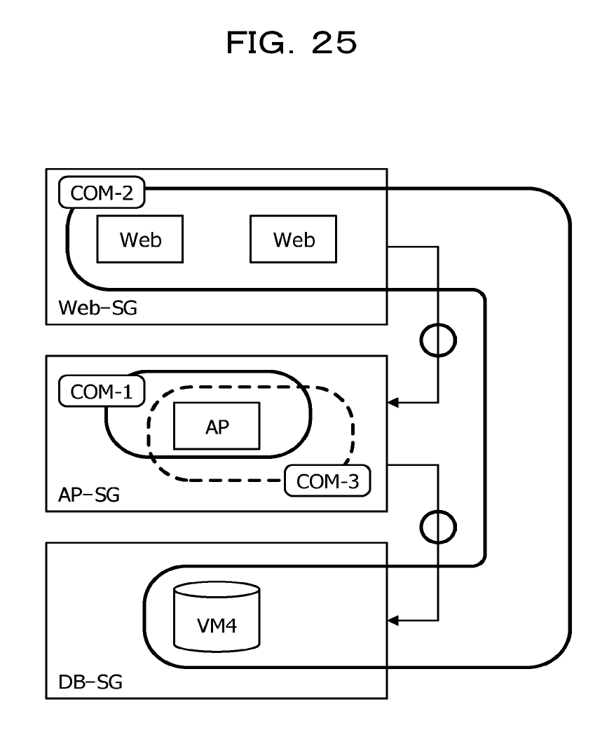

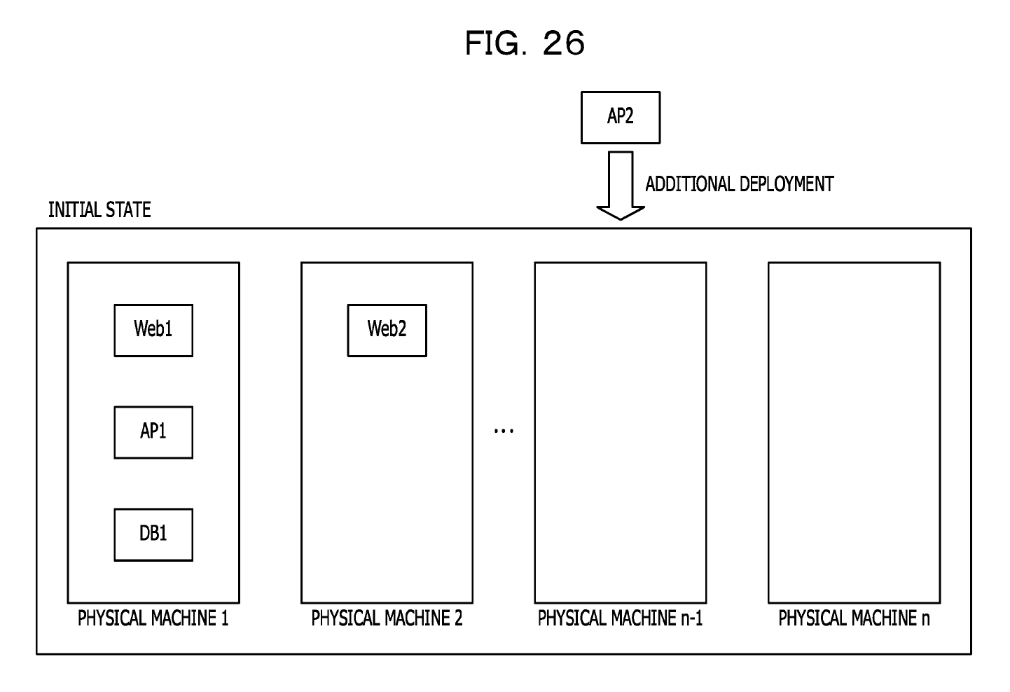

As illustrated in FIG. 25, a COM group is established in each security group. Specifically, a COM group “COM-2” is established in Web-SG and DB-SG, and a COM group “COM-1” and a COM group “COM-3” are established in AP-SG.

As illustrated in FIG. 26, Web1, AP1, and DB1 run in the physical machine 1, and Web2 runs in the physical machine 2. Consider newly deploying AP2 that belongs to AP-SG in that state.

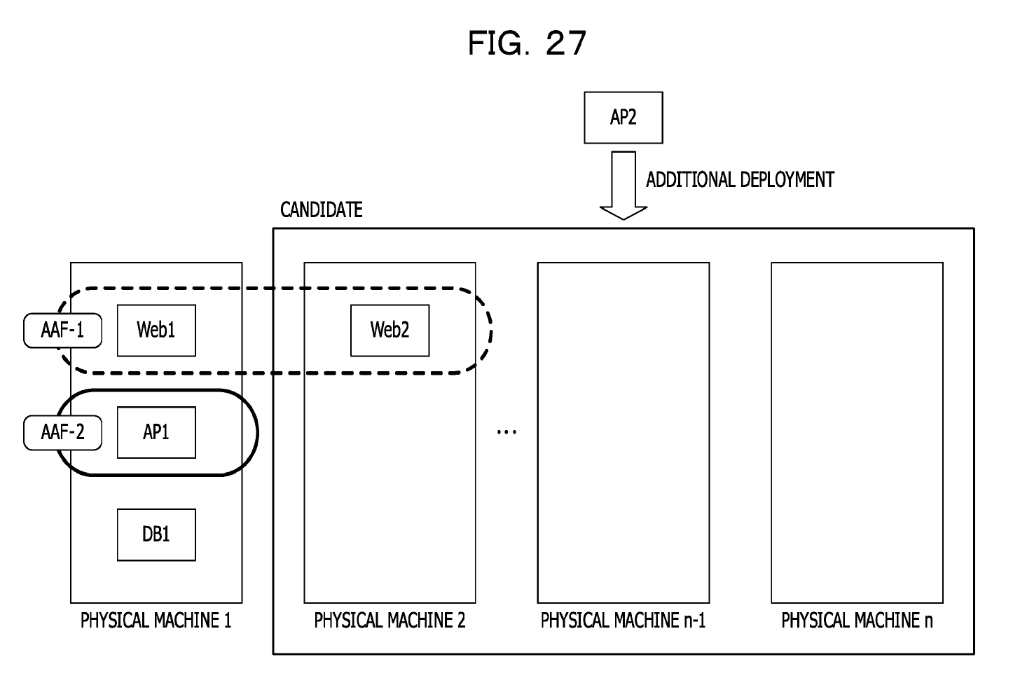

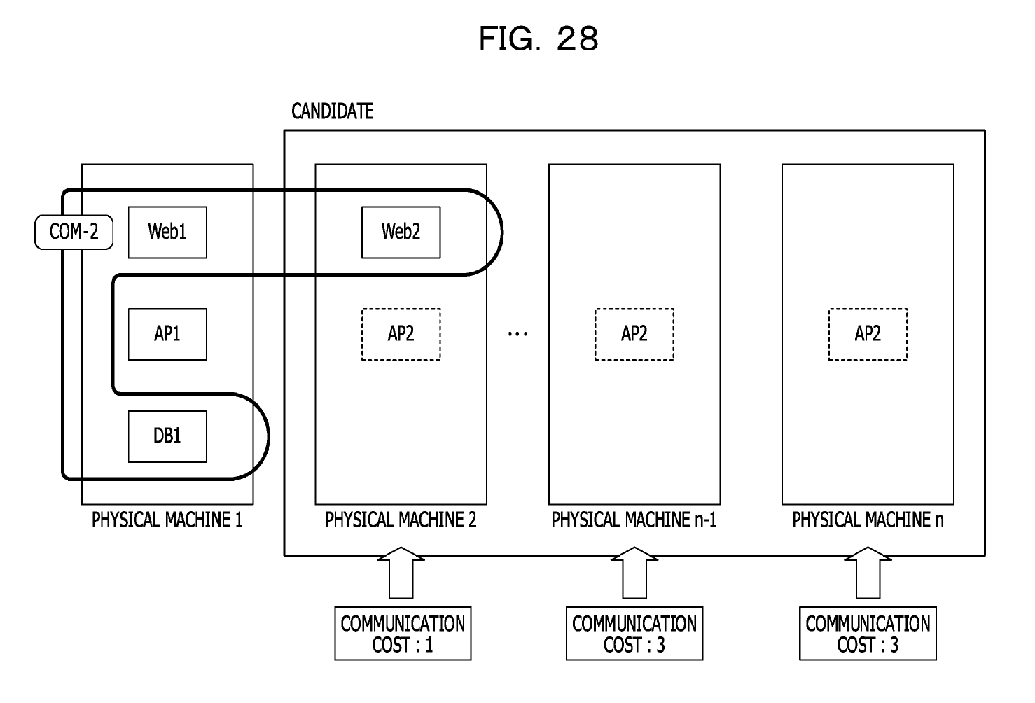

Since AP2 belongs to AP-SG as AP1 does, AP2 is started in a physical machine other than the physical machine 1 due to a startup parameter for the AAF group. In other words, candidates of destination are physical machines 2 to n, as illustrated in FIG. 27.

As illustrated in FIG. 27, a communication cost when AP2 is deployed is calculated for each of the physical machines 2 to n. In the example in FIG. 28, COM-2 is established as a communication partner of AP2, and therefore a communication cost when the AP2 is deployed in the physical machine 2 is expressed as 1+0+1=2, . . . , and a communication cost when AP2 is deployed in a physical machine (n−1) is expressed as 1+1+1=3. A communication cost when AP2 is deployed in a physical machine n is expressed as 1+1+1=3. Therefore, since a physical machine whose communication cost is lowest is the physical machine 2, the physical machine 2 is specified as a destination.

The above embodiment is given for mere illustration. For example, the functional block configuration of the deployment apparatus 1 described above may not agree with an actual program module.

The configurations of the management tables described above are given for mere illustration and are not limited to the configurations. Also in the flowcharts, the order of the processes may be changed unless the processing result changes. Furthermore, the processes may be executed in parallel.

A trigger for the process illustrated in FIG. 15 may not be the update instruction. For example, the process may be started at a predetermined time.

If it is preferable to calculate the communication cost not on a physical machine basis but on a rack or zone basis, the communication costs of deploying VMs may be calculated on such basis.

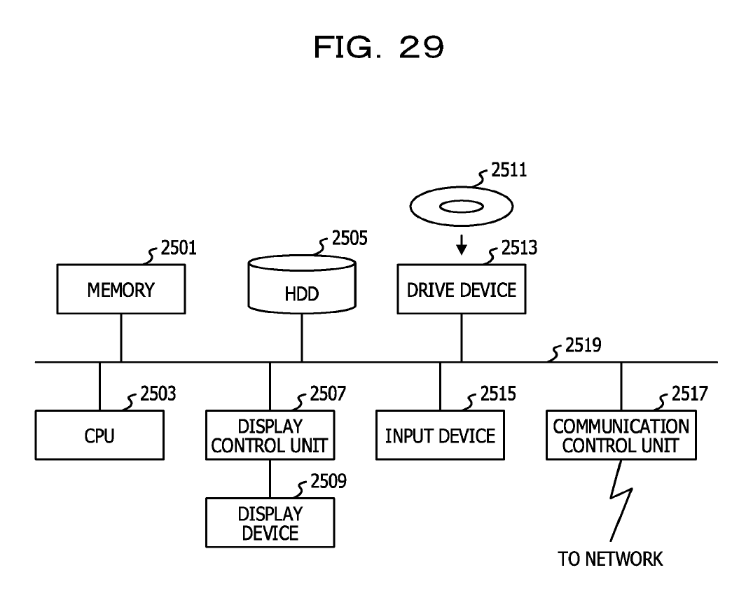

FIG. 29 is a functional block diagram of a computer. The deployment apparatus 1 described above is a computer including a memory 2501, a CPU 2503, a hard disk drive (HDD) 2505, a display control unit 2507 connected to a display 2509, a drive 2513 for a removable disk 2511, an input device 2515, and a communication control unit 2517 for connecting to a network, which are connected together through a bus 2519, as illustrated in FIG. 29. An operating system (OS) and application programs for executing the processes in this embodiment are stored in the HDD 2505. In executing the processes, the programs are read from the HDD 2505 into the memory 2501. The CPU 2503 controls the display control unit 2507, the communication control unit 2517, or the drive 2513 according to the processing details of the application program to perform a predetermined operation. Data in process is mainly stored in the memory 2501. Alternatively, the data may be stored in the HDD 2505. In some embodiments, application programs for executing the above processes are stored in the computer-readable removable disk 2511 for distribution and are installed into the HDD 2505 via the drive 2513. In some embodiments, application programs are installed into the HDD 2505 via a network, such as the Internet, and the communication control unit 2517. Such a computer implements various functions as described above by organically cooperating among hardware such as the CPU 2503 and the memory 2501, and programs such as the OS and application programs.

A summary of the embodiments is as follows.

A method of deployment according to an embodiment includes (A) specifying a group in which communication between virtual machines that belong to the group is not permitted using a first data storage unit that stores information regarding communication rules on virtual machines that belong to individual groups, (B) storing deployment information indicating dispersed deployment in a second data storage unit in association with identification information on the specified group, (C) determining whether the deployment information associated with identification information on a first group is stored in the second data storage unit when receiving an instruction to deploy a first virtual machine that belongs to the first group, and (D) determining a target physical machine in which the first virtual machine is to be deployed from among physical machines in which a virtual machine other than the first virtual machine that belongs to the first group is not running out of a plurality of physical machines when the deployment information is stored in the second data storage unit in association with the identification information on the first group.

This allows dispersed deployment when communication in one group seems not to be permitted even if a configuration for deployment is not prepared. In other words, virtual machines may be deployed in appropriate physical machines.

The process of determining a destination physical machine for the first virtual machine may include (d1) calculating a communication cost when the first virtual machine is operated on each of physical machines in which a virtual machine other than the first virtual machine that belongs to the first group is not running and (d2) specifying a target physical machine in which the first virtual machine is to be deployed based on the calculated communication costs. This allows an optimum physical machine to be determined as a destination in terms of communication costs.

The process of calculating a communication cost may include (d11) calculating a communication cost when the first virtual machine is operated on the physical machine by obtaining a total of communication costs calculated for a plurality of communication partners of the first virtual machine by a predetermined method. The predetermined method may be a method for reducing a communication cost when a communication partner of the first virtual machine runs in an identical physical machine as compared to a communication cost when a communication partner of the first virtual machine runs in a different physical machine. Communication between VMs in an identical physical machine reduces consumption of the band of a network connecting the physical machine. This allows appropriate communication costs to be calculated.

This method of deployment may further include (E) determining a target physical machine in which the first virtual machine is to be deployed from the plurality of physical machines when the deployment information is not stored in the second data storage unit in association with the identification information on the first group. Deploying virtual machines that belong to an identical group in an identical physical machine enhances the efficiency of communication between the virtual machines in the group.

The method of deployment may further include (F) outputting a command to start the first virtual machine in the determined target physical machine. This allows the virtual machine to be started in the destination physical machine.

A program for causing a computer to execute the process according to the above method may be generated. The program is stored in a computer-readable storage medium or a storage unit, such as a flexible disk, a CD-ROM, a magneto-optical disk, a semiconductor memory, or a hard disk. An intermediate processing result is temporarily stored in a storage unit, such as a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method for deploying virtual machines, the method comprising:
first determining a group in which communication between virtual machines that belong to the group is not permitted by referring information regarding communication rules on virtual machines that belong to individual groups in a first data storage;
storing deployment information indicating dispersed deployment in a second data storage in association with identification information on the determined group;
second determining whether the deployment information associated with identification information on a first group is stored in the second data storage when receiving an instruction to deploy a first virtual machine that belongs to the first group; and
third determining a target physical machine in which the first virtual machine is to be deployed from among one or more physical machines in which a second virtual machine that belongs to the first group is not running out of a plurality of physical machines when the second determining determines that the deployment information is stored in the second data storage in association with the identification information on the first group, the second virtual machine being a virtual machine other than the first virtual machine.

2. The method according to claim 1, wherein the third determining includes:
calculating a communication cost when the first virtual machine is operated on each of the one or more physical machines; and
determining a target physical machine in which the first virtual machine is to be deployed based on the communication costs.

3. The method according to claim 2, wherein
the calculating includes calculating a communication cost when the first virtual machine is operated on the physical machine by obtaining a total of communication costs calculated for a plurality of communication destinations with regard to the first virtual machine by a predetermined method, and
the predetermined method is a method for reducing a communication cost when a communication destination of the first virtual machine runs in an identical physical machine as compared to a communication cost when a communication destination of the first virtual machine runs in a different physical machine.

4. The method according to claim 1, further comprising:
fourth determining the target physical machine from the plurality of physical machines when the second determining determines that the deployment information is not stored in the second data storage in association with the identification information on the first group.

5. The method according to claim 1, further comprising:
outputting a command to start the first virtual machine in the target physical machine.

6. A non-transitory storage medium storing a program that causes a computer to execute a process, the process comprising:
first determining a group in which communication between virtual machines that belong to the group is not permitted by referring information regarding communication rules on virtual machines that belong to individual groups in a first data storage;
storing deployment information indicating dispersed deployment in a second data storage in association with identification information on the determined group;
second determining whether the deployment information associated with identification information on a first group is stored in the second data storage when receiving an instruction to deploy a first virtual machine that belongs to the first group; and
third determining a target physical machine in which the first virtual machine is to be deployed from among one or more physical machines in which a second virtual machine that belongs to the first group is not running out of a plurality of physical machines when the second determining determines that the deployment information is stored in the second data storage in association with the identification information on the first group, the second virtual machine being a virtual machine other than the first virtual machine.

7. The storage medium according to claim 6, wherein the third determining includes:
calculating a communication cost when the first virtual machine is operated on each of the one or more physical machines; and
determining a target physical machine in which the first virtual machine is to be deployed based on the communication costs.

8. The storage medium according to claim 7, wherein
the calculating includes calculating a communication cost when the first virtual machine is operated on the physical machine by obtaining a total of communication costs calculated for a plurality of communication destinations with regard to the first virtual machine by a predetermined method, and
the predetermined method is a method for reducing a communication cost when a communication destination of the first virtual machine runs in an identical physical machine as compared to a communication cost when a communication destination of the first virtual machine runs in a different physical machine.

9. The storage medium according to claim 6, wherein the process further comprises:
fourth determining the target physical machine from the plurality of physical machines when the second determining determines that the deployment information is not stored in the second data storage in association with the identification information on the first group.

10. The storage medium according to claim 6, wherein the process further comprises:
outputting a command to start the first virtual machine in the target physical machine.

11. A system comprising:
a memory; and
a processor coupled to the memory and configured to:
determine a group in which communication between virtual machines that belong to the group is not permitted by referring information regarding communication rules on virtual machines that belong to individual groups in a first data storage,
store deployment information indicating dispersed deployment in a second data storage in association with identification information on the determined group,
determine whether the deployment information associated with identification information on a first group is stored in the second data storage when receiving an instruction to deploy a first virtual machine that belongs to the first group, and
determine a target physical machine in which the first virtual machine is to be deployed from among one or more physical machines in which a second virtual machine that belongs to the first group is not running out of a plurality of physical machines when it is determined that the deployment information is stored in the second data storage in association with the identification information on the first group, the second virtual machine being a virtual machine other than the first virtual machine.

12. The system according to claim 11, wherein the processor is configured to:
calculate a communication cost when the first virtual machine is operated on each of the one or more physical machines, and
determine a target physical machine in which the first virtual machine is to be deployed based on the communication costs.

13. The system according to claim 12, wherein
the processor is configured to calculate a communication cost when the first virtual machine is operated on the physical machine by obtaining a total of communication costs calculated for a plurality of communication destinations with regard to the first virtual machine by a predetermined method, and
the predetermined method is a method for reducing a communication cost when a communication destination of the first virtual machine runs in an identical physical machine as compared to a communication cost when a communication destination of the first virtual machine runs in a different physical machine.

14. The system according to claim 11, wherein the processor is configured to:
determine the target physical machine from the plurality of physical machines when it is determined that the deployment information is not stored in the second data storage in association with the identification information on the first group.

15. The system according to claim 11, wherein the processor is configured to:
output a command to start the first virtual machine in the target physical machine.
